(19) United States
(12) Patent Application Publication
(10) Pub. No.: US 2019/0197349 A1
(43) Pub. Date: Jun. 27, 2019

(54) IMAGE IDENTIFICATION METHOD AND IMAGE IDENTIFICATION DEVICE

(71) Applicant: VIVOTEK INC., New Taipei City (TW)

(72) Inventor: Hsun-Shun Yu, New Taipei City (TW)

(21) Appl. No.: 16/226,551

(22) Filed: Dec. 19, 2018

(30) Foreign Application Priority Data
Dec. 22, 2017 (TW) 106145292

(51) Int. Cl. G06K 9/62; G06K 9/46; G06T 7/174

(52) U.S. Cl. CPC G06K 9/6212; G06T 7/174; G06K 9/4642

(57) ABSTRACT

An image identification method capable of preventing identification accuracy from affecting by illumination change is applied to an image identification device. The image identification method includes acquiring a first monitoring image and a second monitoring image respectively captured before and after the illumination change, dividing the first monitoring image and the second monitoring image into a plurality of areas, computing a pixel difference between each area of the second monitoring image and a corresponding area of the first monitoring image, setting pixel difference of the plurality of areas as at least one group, and determining whether to filter an area related to the at least one group according to distributed concentration of the at least one group.

### BACKGROUND OF THE INVENTION

### 1. Field of the Invention

The present invention relates to an image identification method and a related image identification device, and more particularly, to an image identification method of preventing identification accuracy from being affected by illumination change and a related image identification device.

### 2. Description of the Prior Art

Video content analyzing technology can be applied to a monitoring apparatus and used to detect a moving object inside a monitoring region of the monitoring apparatus for increasing image monitoring efficiency and safety. The video content analyzing technology is easily affected by illumination change when executing motion detection, and the illumination change may be resulted from sunlight, vehicle light, street light and a shadow of the object. The illumination change may result in variation of pixel value about the monitoring image, which is not an aim of the video content analyzing technology, thus a result of the video content analyzing technology has noise and accuracy of the video content analyzing technology is decreased accordingly.

The conventional video content analyzing technology has to spend large computation and a long period to detect and analyze the illumination change of the monitoring image, and cannot immediately acquire a result of detecting and filtering the illumination change. Therefore, conventional computation of detecting and filtering the illumination change is executed by a backend server, which has preferred computational ability, but cannot be executed by the monitoring camera with limited computational ability.

### SUMMARY OF THE INVENTION

The present invention provides an image identification method of preventing identification accuracy from being affected by illumination change and a related image identification device for solving above drawbacks.

According to the claimed invention, an image identification method of preventing identification accuracy from being affected by illumination change includes acquiring a first monitoring image and a second monitoring image respectively captured before and after the illumination change, dividing the first monitoring image and the second monitoring image respectively into a plurality of areas, computing pixel difference between each area of the second monitoring image and a corresponding area of the first monitoring image, classifying the pixel difference corresponding to the plurality of areas into at least one group, and determining whether an area related to the at least one group is filtered according to distributed concentration of the at least one group.

According to the claimed invention, an image identification device with a function of preventing identification accuracy from being affected by illumination change is disclosed. The image identification device includes an image receiver and an operation processor. The image receiver is adapted to receive a plurality of monitoring images. The operation processor is electrically connected with the image receiver and adapted to acquire a first monitoring image and a second monitoring image respectively captured before and after the illumination change, divide the first monitoring image and the second monitoring image respectively into a plurality of areas, compute pixel difference between each area of the second monitoring image and a corresponding area of the first monitoring image, classify the pixel difference corresponding to the plurality of areas into at least one group, and determine whether an area related to the at least one group is filtered according to distributed concentration of the at least one group, for excluding some area within the monitoring image having the illumination change but without foreground variation.

The image identification method and the image identification device of the present invention can compute the pixel difference between areas from different monitoring images captured before and after the illumination change, and classify the pixel difference of all areas to determine whether one of the groups has the greater distributed concentration. The area related to the group having the greater distributed concentration (which means conforms to a specific condition) can be represented as the interfered area affected by the illumination change and having equivalent pixel variation inside the monitoring image, so that the present invention can rapidly and effectively identify the real object contour by excluding interference of the illumination change without heavy computation, and the image identification method can have advantages of decreasing computation data, economizing hardware cost and shortening a computation period because the present invention has no heavy computation. The image identification method of the present invention can be executed by a device with limited computational resource, such as the common camera, for immediately completing functions of detecting and filter the illumination change.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an image identification device according to an embodiment of the present invention.

FIG. 2 is a flow chart of an image identification method according to the embodiment of the present invention.

FIG. 3 is a diagram of a monitoring image without illumination change according to the embodiment of the present invention.

FIG. 4 is a diagram of the monitoring images respectively captured before and after the illumination change according to the embodiment of the present invention.

FIG. 5 is a diagram of statistic information related to the monitoring images according to the embodiment of the present invention.

FIG. 6 is a diagram of statistic information related to the monitoring image according to another embodiment of the present invention.

FIG. 7 is a diagram of statistic information related to the monitoring image according to another embodiment of the present invention.

### DETAILED DESCRIPTION

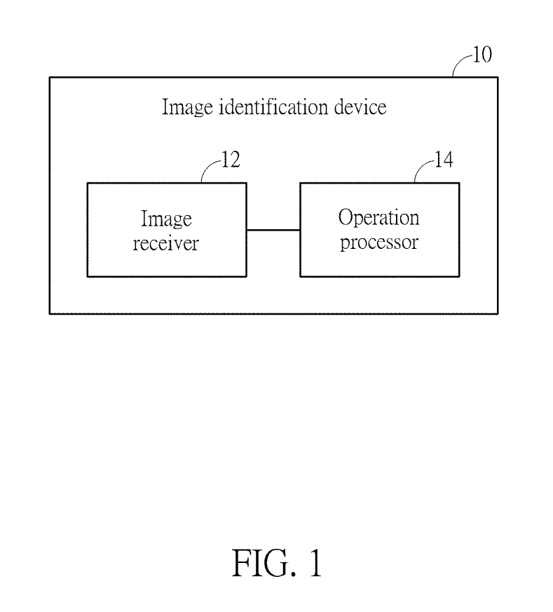

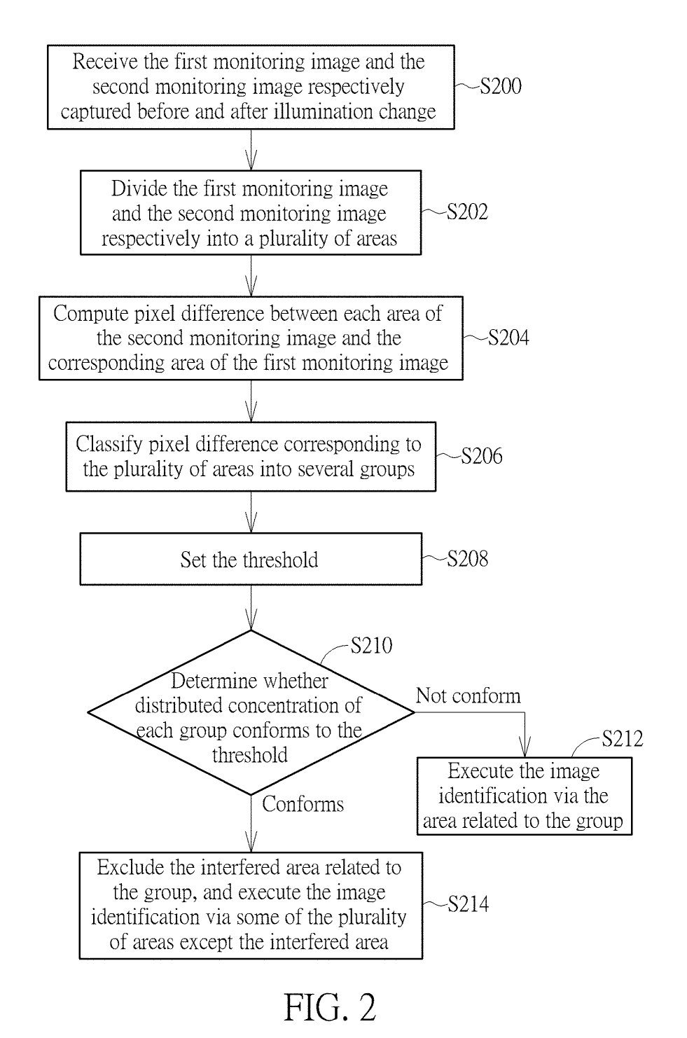

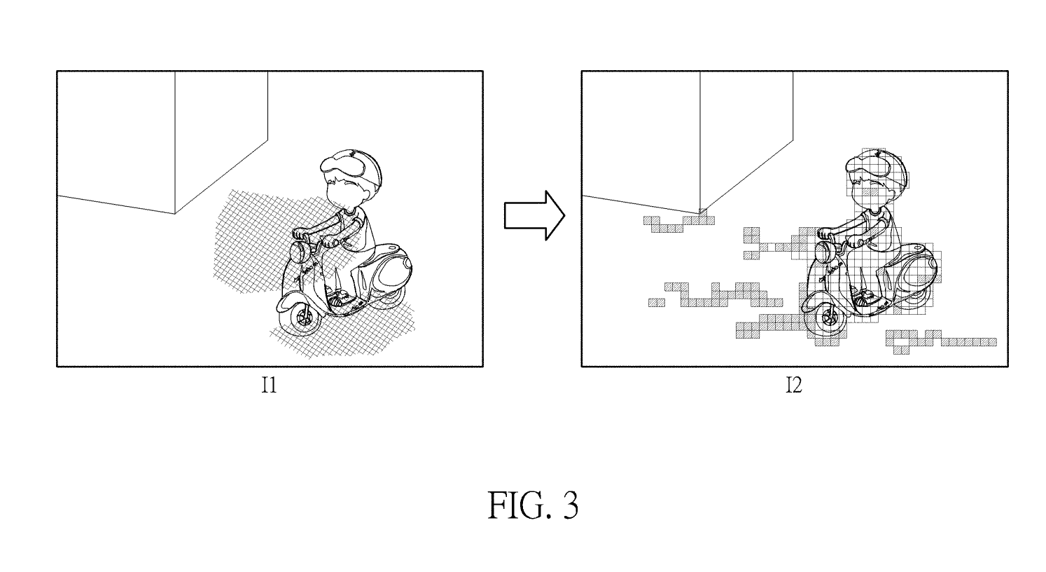

Please refer to FIG. 1 to FIG. 3. FIG. 1 is a functional block diagram of an image identification device 10 according to an embodiment of the present invention. FIG. 2 is a flow chart of an image identification method according to the embodiment of the present invention. FIG. 3 is a diagram of a monitoring image without illumination change according to the embodiment of the present invention. The image identification method illustrated in FIG. 2 is suitable for the image identification device 10 shown in FIG. 1. The image identification device 10 can include an image receiver 12 and an operation processor 14 electrically connected to each other. The image receiver 12 can be used to receive a plurality of monitoring images. The operation processor 14 can execute the image identification method according to the plurality of monitoring images, for excluding some area having the illumination change but no foreground variation inside the monitoring images to increase image identification accuracy.

If a vehicle appears in a monitoring region of the image identification device 10, vehicle light may result in noise of the foreground when executing the image identification, and the image identification method of the present invention can be applied to filter the noise resulted from the vehicle light within the monitoring image for acquiring an accurate identification result. As shown in FIG. 3, the monitoring image I1 not processed by the image identification has the motorcycle, and a region illuminated by the vehicle light is marked by obliquely crossed lines; in the monitoring image I2 processed by the image identification, a region related to a moving object, such as the motorcycle, is marked by grids, therefore a contour of the motorcycle can be marked through the grids and some region irrelevant to the motorcycle contour can be also marked due to reflection or scattering of the vehicle light. The image identification method of the present invention can identify and filter the region (which is marked by oblique grids) irrelevant to the motorcycle contour but reserve other regions (which is marked by hollow grids) relevant to the motorcycle contour.

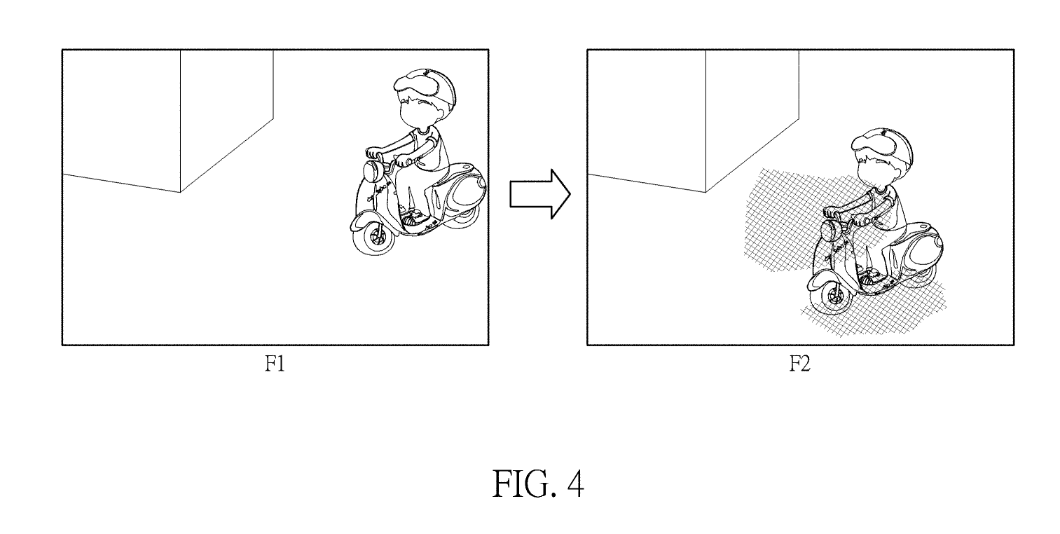

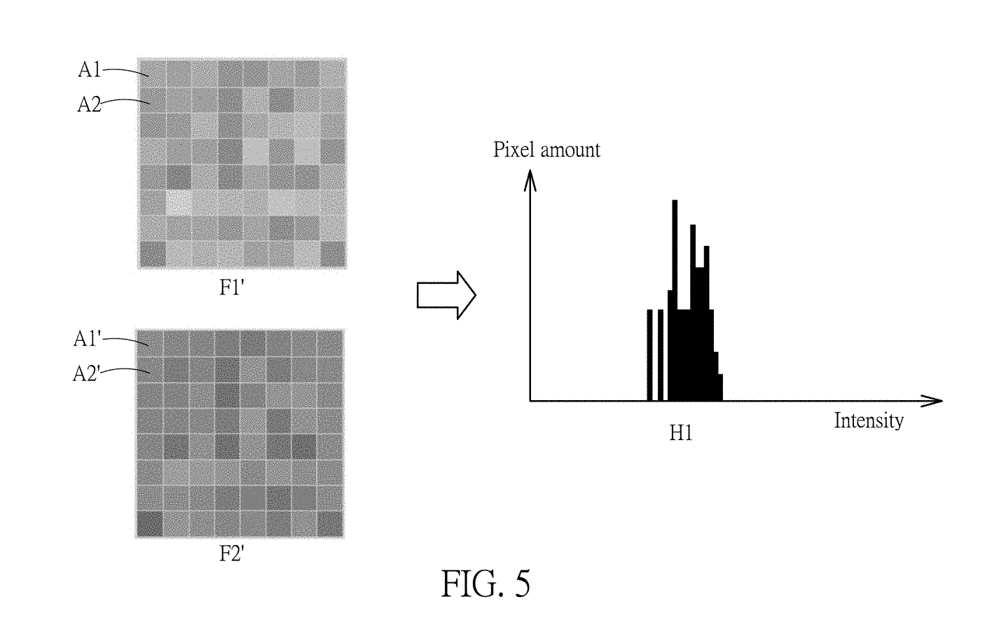

Please refer to FIG. 4 and FIG. 5. FIG. 4 is a diagram of the monitoring images respectively captured before and after the illumination change according to the embodiment of the present invention. FIG. 5 is a diagram of statistic information related to the monitoring images according to the embodiment of the present invention. With respect to the image identification method, step S200 is executed that the image receiver 12 can receive a first monitoring image F1 and a second monitoring image F2 respectively captured before and after the illumination change. The vehicle inside the first monitoring image F1 does not turn on the light, and the vehicle inside the second monitoring image F2 turns on the light. A region related to the vehicle light can be marked by oblique lines. Then, step S202 is executed that the operation processor 14 can divide the first monitoring image F1 and the second monitoring image F2 respectively into a plurality of areas, such as a first transforming image F1′ and a second transforming image F2′ shown in FIG. 5. Each area may contain one pixel, and color of the area is performed by a value of the foresaid pixel. Each area may further contain a matrix having a plurality of pixels, and color of the area is performed by an average value of the plurality of pixels. The first transforming image F1′ and the second transforming image F2′ can correspond to the first monitoring image F1 and the second monitoring image F2, respectively.

Then, step S204 is executed that the operation processor 14 can respectively compute pixel difference between each area of the second monitoring image F2 (or the related second transforming image F2′) and a corresponding area of the first monitoring image F1 (or the related first transforming image F1′), such as the pixel difference between the area A1 and the area A1′, and the pixel difference between the area A2 and the area A2′. The pixel difference can equal a pixel value of one area minus a pixel value of other area, or can be an absolute value of a result equals the pixel value of one area minus the pixel value of other area. The preferred embodiment may use the absolute value of the pixel difference. Then, steps S206, S208 and S210 is executed that the operation processor 14 can classify (or cluster) the pixel difference corresponding to the plurality of areas into one or more groups, and set a threshold and then determine whether distributed concentration of each group conforms to the threshold. As the distributed concentration of one group does not conform to the threshold, step S212 can be executed to execute the image identification via an area related to the said group, such as the hollow grids shown in FIG. 3. As the distributed concentration of one group conforms to the threshold, step S214 can be executed to define an area related to the said group belonging to an interfered area (which should be filtered), such as the oblique grids shown in FIG. 3, and the image identification is executed via some of the plurality of areas except the interfered area.

In step S206, if the pixel difference is classified into one group, the image identification method can compare the foresaid group with the threshold to find out the interfered area. If the pixel difference is classified into several groups, the image identification method can set a selective condition; when each distributed concentration of several groups conforms to the selective condition, the areas related to the several groups belongs to the interfered area, so that the image identification can be executed via some of the plurality of areas except the interfered area. When the distributed concentration of one or several groups does not conform to the selective condition, the group not conforming to the condition is represented as the non-interfered area. The image identification method can optionally establish the statistic information according to pixel difference about the plurality of areas, and the statistic information is a histogram map H1 of the pixel difference to an amount of pixels. When the pixel difference are gathered in somewhere of the histogram map, the area related to the group belongs to a region inside the monitoring image affected by the illumination change and prepared to be filtered as long as the distributed concentration conforms to the threshold.

The image identification method can use a k-means algorithm to classify the pixel difference corresponding to the plurality of areas within the statistic information, and an actual application is not limited to the above-mentioned embodiment. The foresaid threshold and the selective condition can be defined as variance of statistics. The variance can indicate an average distance between each datum and an average number, and be an index for measuring a degree of data distribution and determining whether the distributed concentration of each group conforms to a filtering condition. The present invention further may use other statistical method to decide the distributed concentration of each group, which depends on design demand.

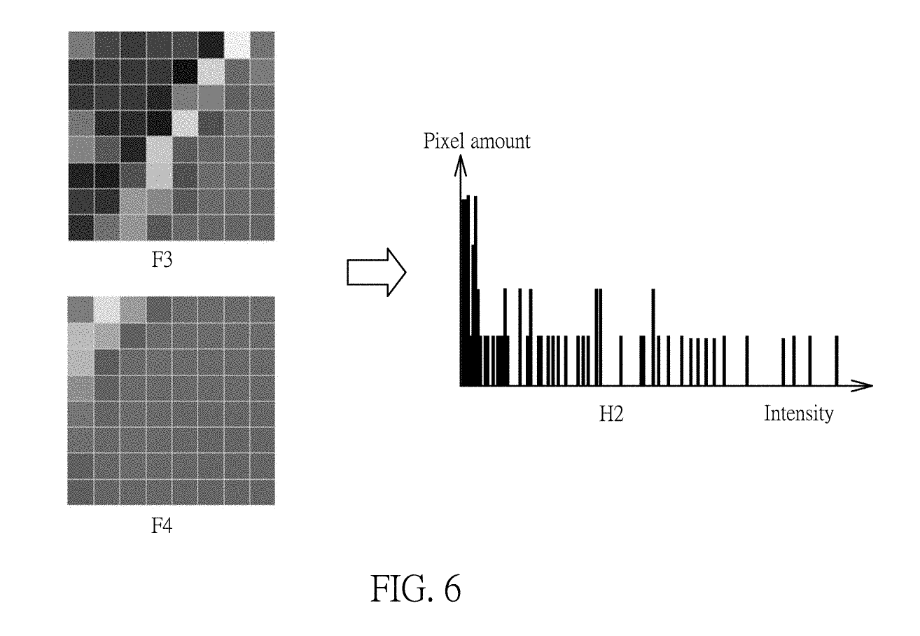

As shown in FIG. 5, pixel variation between areas of the first transforming image F1′ and the second transforming image F2′ may be nearly the same or similar values, which means the monitoring image is affected by the illumination change. Please refer to FIG. 6. FIG. 6 is a diagram of statistic information related to the monitoring image according to another embodiment of the present invention. If the monitoring image does not have the illumination change and shows real object motion inside the monitoring region, the pixel variation between the areas of the transforming images F3 and F4 can be randomly generated. When the pixel difference between each area of the transforming image F3 and a corresponding area of the transforming image F4 is classified, the image identification method can determine that the distributed concentration of the group does not conform to the threshold, which means the pixel difference of a histogram map H2 based on the statistic information is dispersed; in the meantime, the image identification method can determine the pixel variation between the transforming images F3 and F4 belongs to the real foreground variation instead of the illumination change.

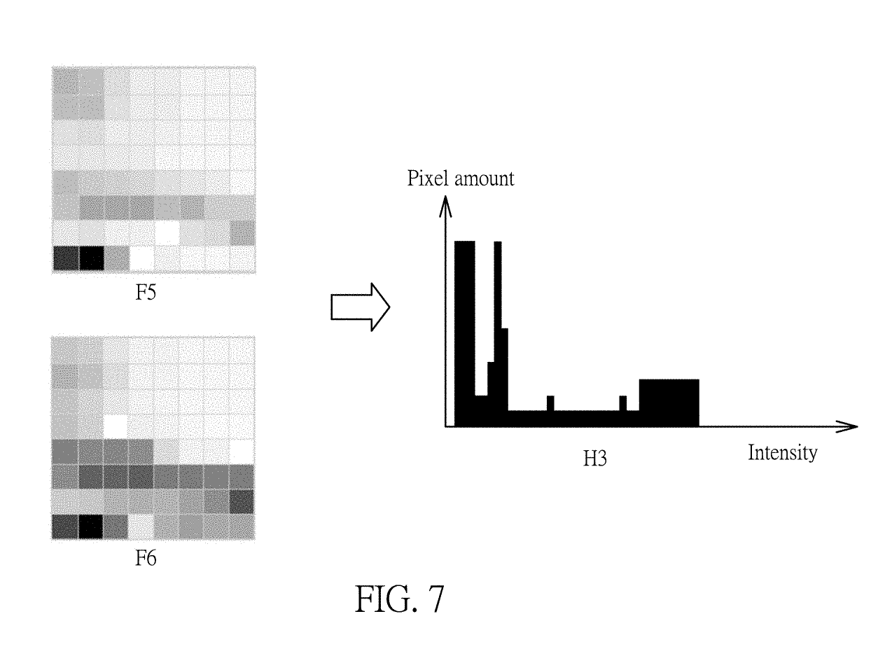

Please refer to FIG. 7. FIG. 7 is a diagram of statistic information related to the monitoring image according to another embodiment of the present invention. Two monitoring images captured before and after the illumination change can respectively be transforming images F5 and F6. The image identification method can acquire the statistic information shown in a histogram map H3 after classifying the pixel difference between areas of the transforming images F5 and F6. As shown in FIG. 7, the transforming images F5 and F6 have local illumination change, which means a lower part of the monitoring image is dark and an upper part of the monitoring image is unvaried, and the pixel difference between the transforming images F5 and F6 within the histogram map H3 can be classified into two groups. The image identification method can decide whether the pixel difference of each group is greater than a critical value T. For example, the pixel difference of the left-side group is close to zero, and related areas can be indicated as a part of the monitoring image without the illumination change; the pixel difference of the right-side group is large and over the critical value, so that other related areas can be indicated as other part of the monitoring image having the illumination change, and belong to the interfered area prepared to be filtered.

In conclusion, the image identification method and the image identification device of the present invention can compute the pixel difference between areas from different monitoring images captured before and after the illumination change, and classify the pixel difference of all areas to determine whether one of the groups has the greater distributed concentration. The area related to the group having the greater distributed concentration (which means conforms to a specific condition) can be represented as the interfered area affected by the illumination change and having equivalent pixel variation inside the monitoring image, so that the present invention can rapidly and effectively identify the real object contour by excluding interference of the illumination change without heavy computation, and the image identification method can have advantages of decreasing computation data, economizing hardware cost and shortening a computation period because the present invention has no heavy computation. The image identification method of the present invention can be executed by a device with limited computational resource, such as the common camera, for immediately completing functions of detecting and filter the illumination change.

Those skilled in the art will readily observe that numerous modifications and alterations of the device and method may be made while retaining the teachings of the invention. Accordingly, the above disclosure should be construed as limited only by the metes and bounds of the appended claims.

what is claimed is:

1. An image identification method of preventing identification accuracy from being affected by illumination change, comprising:
acquiring a first monitoring image and a second monitoring image respectively captured before and after the illumination change;
dividing the first monitoring image and the second monitoring image respectively into a plurality of areas;
computing pixel difference between each area of the second monitoring image and a corresponding area of the first monitoring image;
classifying the pixel difference corresponding to the plurality of areas into at least one group; and
determining whether an area related to the at least one group is filtered according to distributed concentration of the at least one group.

2. The image identification method of claim 1, wherein determining whether the area related to the at least one group is filtered according to the distributed concentration of the at least one group comprises:
setting a threshold;
defining the area related to the at least one group belongs to an interfered area when the distributed concentration conforms to the threshold; and
executing image identification via some of the plurality of areas except the interfered area.

3. The image identification method of claim 2, wherein the image identification is executed via the area related to the at least one group when the distributed concentration does not conform to the threshold.

4. The image identification method of claim 1, wherein determining whether the area related to the at least one group is filtered according to the distributed concentration of the at least one group comprises:
filtering the area related to the at least one group when the pixel difference of the at least one group is greater than a critical value.

5. The image identification method of claim 1, wherein each of the plurality of areas contains a matrix having several pixels, the pixel difference equals a pixel value of the each area of the second monitoring image minus a pixel value of the corresponding area of the first monitoring image, or the pixel difference is an absolute value of a result equals the pixel value of the each area of the second monitoring image minus the pixel value of the corresponding area of the first monitoring image.

6. The image identification method of claim 1, further comprising:
establishing statistic information in accordance with the pixel difference corresponding to the plurality of areas;
classifying the pixel difference corresponding to the plurality of areas within the statistic information into at least one group; and
determining whether an area related to the at least one group is filtered according to distributed concentration of the at least one group.

7. The image identification method of claim 6, wherein the statistic information is distribution of the pixel difference to an amount of pixels.

8. The image identification method of claim 1, wherein the pixel difference are classified via a k-means algorithm.

9. The image identification method of claim 1, wherein the pixel difference are further divided into a plurality of groups, and the image identification method determines whether areas related to the plurality of groups are filtered according to each distributed concentration of the plurality of groups.

10. The image identification method of claim 9, wherein determining whether the areas related to the plurality of groups is filtered according to the each distributed concentration of the plurality of groups comprises:
setting a selective condition;
defining the areas related to the plurality of groups belongs to interfered areas when the each distributed concentration of the plurality of groups conforms to the selective condition; and
executing image identification via some of the plurality of areas except the interfered areas.

11. An image identification device with a function of preventing identification accuracy from being affected by illumination change, the image identification device comprising:
an image receiver adapted to receive a plurality of monitoring images; and
an operation processor electrically connected with the image receiver and adapted to acquire a first monitoring image and a second monitoring image respectively captured before and after the illumination change, divide the first monitoring image and the second monitoring image respectively into a plurality of areas, compute pixel difference between each area of the second monitoring image and a corresponding area of the first monitoring image, classify the pixel difference corresponding to the plurality of areas into at least one group, and determine whether an area related to the at least one group is filtered according to distributed concentration of the at least one group, for excluding some area within the monitoring image having the illumination change but without foreground variation.

12. The image identification device of claim 11, wherein the operation processor is further adapted to set a threshold, define the area related to the at least one group belongs to an interfered area when the distributed concentration conforms to the threshold, and execute image identification via some of the plurality of areas except the interfered area.

13. The image identification device of claim 12, wherein the image identification is executed via the area related to the at least one group when the distributed concentration does not conform to the threshold.

14. The image identification device of claim 11, wherein the operation processor is further adapted to filter the area related to the at least one group when the pixel difference of the at least one group is greater than a critical value.

15. The image identification device of claim 11, wherein each of the plurality of areas contains a matrix having of several pixels, the pixel difference equals a pixel value of the each area of the second monitoring image minus a pixel value of the corresponding area of the first monitoring image, or the pixel difference is an absolute value of a result equals the pixel value of the each area of the second monitoring image minus the pixel value of the corresponding area of the first monitoring image.

16. The image identification device of claim 11, wherein the operation processor is further adapted to establish statistic information in accordance with the pixel difference corresponding to the plurality of areas, classify the pixel difference corresponding to the plurality of areas within the statistic information into at least one group, and determine whether an area related to the at least one group is filtered according to distributed concentration of the at least one group.

17. The image identification device of claim 16, wherein the statistic information is distribution of the pixel difference to an amount of pixels.

18. The image identification device of claim 11, wherein the pixel difference are classified via a k-means algorithm.

19. The image identification device of claim 11, wherein the pixel difference are further divided into a plurality of groups, and the image identification method determines whether areas related to the plurality of groups are filtered according to each distributed concentration of the plurality of groups.

20. The image identification device of claim 19, wherein the operation processor is further adapted to set a selective condition, define the areas related to the plurality of groups belongs to interfered areas when the each distributed concentration of the plurality of groups conforms to the selective condition, and execute image identification via some of the plurality of areas except the interfered areas.
